(19) United States
(12) Patent Application Publication
(10) Pub. No.: US 2013/0163468 A1
(43) Pub. Date: Jun. 27, 2013

(54) WIRELESS DEVICE AND METHOD FOR SEARCHING FOR NEIGHBORHOOD DEVICE

(71) Applicant: Electronics and Telecommunications Research Institute, Daejeon (KR)

(72) Inventors: Sung Geun JIN, Daejeon (KR); Jin Kyeong Kim, Daejeon (KR); Hyun Kyu Chung, Daejeon (KR)

(73) Assignee: Electronics and Telecommunications Research Institute, Daejeon (KR)

(21) Appl. No.: 13/723,686

(22) Filed: Dec. 21, 2012

(30) Foreign Application Priority Data
Dec. 23, 2011 (KR) 10-2011-0140845

(51) Int. Cl. H04W 4/06

(52) U.S. Cl. CPC H04W 4/06
USPC 370/254

(57) ABSTRACT

Provided is a wireless device and method for searching for a neighboring device in which the wireless device may spread a probe request message for searching for neighboring wireless devices using a predetermined spreading code, and broadcast the spread probe request message, and may receive and thereby de-spread a wireless signal and verify whether a neighboring wireless device is present using a probe response message when the probe response message is included in the de-spread wireless signal.

### CROSS-REFERENCE TO RELATED APPLICATION

This application claims the priority benefit of Korean Patent Application No. 10-2011-0140845, filed on Dec. 23, 2011, in the Korean Intellectual Property Office, the disclosure of which is incorporated herein by reference.

### BACKGROUND

1. Field of the Invention

The present invention relates to technology that enables a wireless device to quickly search for a neighboring wireless device and thereby decrease an initial access time.

2. Description of the Related Art

In a conventional wireless local area network (WLAN), a wireless terminal device performs a scanning operation in order to search for a neighboring device. During the scanning operation, the wireless terminal device may broadcast a probe request message using a predetermined channel and may wait for a probe response message that is a response message from an access point for a predetermined period of time. When the probe response message is received, the wireless terminal device may verify that the access point is present in a corresponding broadcast channel. On the contrary, when the probe response message is not received even after waiting for a predetermined period of time, the wireless terminal device may determine that the access point is absent in the corresponding channel. The above process may be performed with respect to all the available channels.

The conventional method may have the following two issues:

First, an amount of standby time used after broadcasting the probe request cannot be confirmed and thus, a success probability about verifying the presence of a neighboring device may vary based on a standby time.

Second, a standby operation for broadcasting the probe request message and receiving the probe response message needs to be performed with respect to all the channels and thus, a search time may be correspondingly delayed.

### SUMMARY

An aspect of the present invention provides a wireless device and method for searching for a neighboring device.

Another aspect of the present invention also provides a wireless device and method for searching for a neighboring wireless device by transmitting a spread probe request message and receiving a spread probe response message from the neighboring wireless device.

According to an aspect of the present invention, there is provided a wireless device to search for a neighboring device, including: a probe request message generator to generate a probe request message for searching for neighboring wireless devices; a spreader to spread the probe request message using a spreading code that is predetermined for spreading; and a communication unit to broadcast the spread probe request message.

The communication unit may receive a wireless signal, and the wireless device may further include: a de-spreader to de-spread the wireless signal using a spreading code that is predetermined for de-spreading; a probe response message verifying unit to verify a probe response message in the de-spread wireless signal; and a controller to verify whether a neighboring wireless device is present using the probe response message.

According to another aspect of the present invention, there is provided a neighboring wireless device responding to a probe request, including: a communication unit to receive a wireless signal; a de-spreader to de-spread the wireless signal using a spreading code that is predetermined for de-spreading; a probe request message verifying unit to verify a probe request message in the de-spread wireless signal; and a controller to determine whether to respond to the probe request message.

The neighboring wireless device may further include: a probe response message generator to generate a probe response message when the controller determines to respond to the probe request message; and a spreader to spread the probe response message using a spreading code that is predetermined for spreading. The communication unit may broadcast the spread probe response message.

According to still another aspect of the present invention, there is provided a method of searching for a neighboring device, the method including: generating a probe request message for searching for neighboring wireless devices; spreading the probe request message using a spreading code that is predetermined for spreading; and broadcasting the spread probe request message.

The method may further include: receiving a wireless signal; de-spreading the wireless signal using a spreading code that is predetermined for de-spreading; verifying a probe response message in the de-spread wireless signal; and verifying whether a neighboring wireless device is present using the probe response message, when the probe response message is included in the wireless signal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a procedure of searching for a neighboring wireless device according to an embodiment of the present invention;

FIG. 2 is a block diagram illustrating a configuration of a wireless device to search for a neighboring wireless device according to an embodiment of the present invention;

FIG. 3 is a block diagram illustrating a configuration of a neighboring wireless device responding to a probe request according to an embodiment of the present invention;

FIG. 4 is a flowchart illustrating a process in which a wireless device searches for a neighboring wireless device according to an embodiment of the present invention; and

FIG. 5 is a flowchart illustrating a process in which a neighboring wireless device responds to a probe request according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

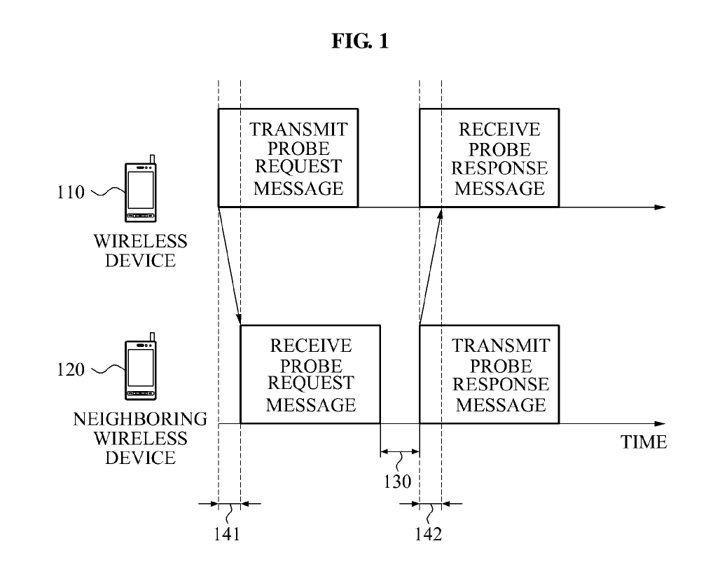

FIG. 1 is a diagram illustrating a procedure of searching for a neighboring wireless device 120 according to an embodiment of the present invention.

Referring to FIG. 1, a wireless device 110 may spread a probe request message and transmit the spread probe request message to the neighboring wireless device 120. Here, a propagation delay 141 may occur based on a distance.

The neighboring wireless device 120 receiving the probe request message may wait for a predetermined standby time 130. Next, the neighboring wireless device 120 may spread a probe response message and transmit the spread probe response message to the wireless device 110. Here, a propagation delay 142 may also occur based on a distance.

The wireless device 110 receiving the probe response message may verify the presence of the neighboring wireless device 120 using the probe response message.

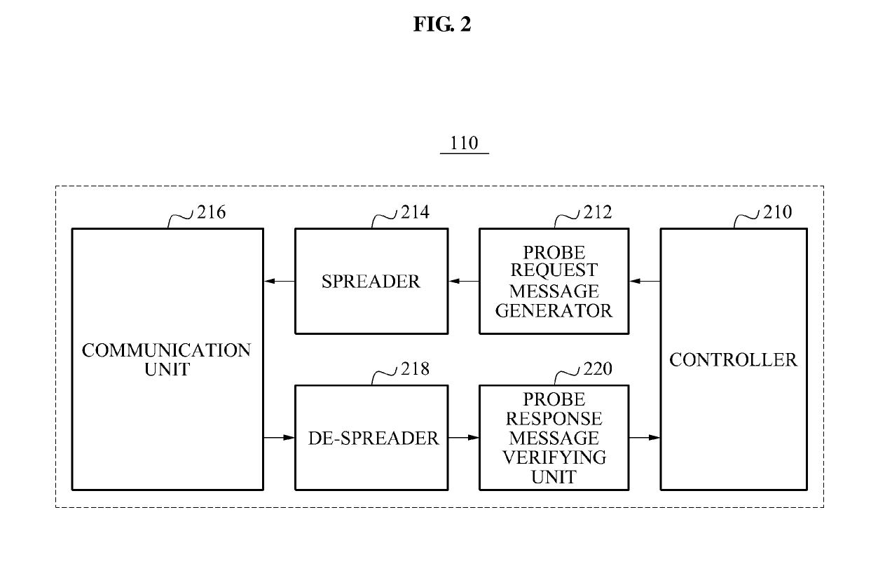

FIG. 2 is a block diagram illustrating a configuration of the wireless device 110 to search for the neighboring wireless device 120 according to an embodiment of the present invention.

Referring to FIG. 2, the wireless device 110 may include a controller 210, a probe request message generator 212, a spreader 214, a communication unit 216, a de-spreader 218, and a probe response message verifying unit 220.

The probe request message generator 212 may generate a probe request message for searching for neighboring wireless devices according to control of the controller 210.

The spreader 214 may spread the probe request message using a predetermined spreading code.

When a plurality of channels is to be searched, the spreader 214 may spread the probe request message for each channel, using a spreading code that is predetermined for each channel.

The communication unit 216 functions to transmit and receive a wireless signal of data that is input and output via an antenna (not shown). For example, in the case of transmitting a wireless signal, the communication unit 216 may perform channel coding and spreading of data to be transmitted and then perform radio frequency (RF) processing of the data and thereby transmit an RF signal. In the case of receiving a wireless signal, the communication unit 216 may convert the received RF signal to a baseband signal, and may perform de-spreading and channel decoding of the baseband signal and thereby restore the data.

The communication unit 216 may broadcast the spread probe request message.

When a plurality of channels is to be searched, the communication unit 216 may broadcast the spread probe request message using each corresponding channel.

Next, the communication unit 216 may receive a wireless signal.

The de-spreader 218 may de-spread the wireless signal using a spreading code that is predetermined for de-spreading.

The probe response message verifying unit 220 may verify whether a probe response message is present in the de-spread wireless signal.

The controller 210 may control the overall operation of the wireless device 110, and may verify whether a probe event for searching for a neighboring wireless device has occurred. When the probe event occurs, the controller 210 may control the probe request message generator 212 to generate a probe request message.

Also, the controller 210 may verify neighboring wireless devices using the probe response message that is verified by the probe response message verifying unit 220.

When the probe response message is received, the controller 210 may estimate a to distance from the neighboring wireless device 120 having transmitted the probe response message, based on a predetermined standby time and a propagation delay time occurring in transmitting the probe request message and receiving the probe response message. Here, the predetermined standby time corresponds to an amount of standby time used until the neighboring wireless device 120 transmits the probe response message after receiving the probe request message.

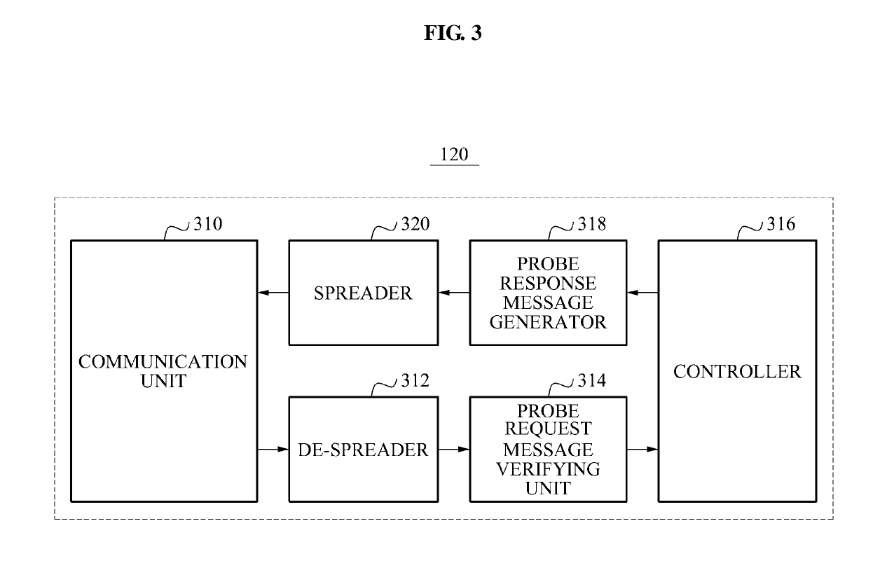

FIG. 3 is a block diagram illustrating a configuration of the neighboring wireless device 120 responding to a probe request according to an embodiment of the present invention.

Referring to FIG. 3, the neighboring wireless device 120 may include a communication unit 310, a de-spreader 312, a probe request message verifying unit 314, a controller 316, a probe response message generator 318, and a spreader 320.

The communication unit 310 functions to transmit and receive a wireless signal of data that is input and output via an antenna (not shown). For example, in the case of transmitting a wireless signal, the communication unit 310 may perform channel coding and spreading of data to be transmitted and then perform radio frequency (RF) processing of the data and thereby transmit an RF signal. In the case of receiving a wireless signal, the communication unit 310 may convert the received RF signal to a baseband signal, and may perform de-spreading and channel decoding of the baseband signal and thereby restore the data.

The communication unit 310 may periodically receive the wireless signal in order to receive the probe request message.

The de-spreader 312 may de-spread the wireless signal using a spreading code that is predetermined for de-spreading.

The probe request message verifying unit 314 may verify the probe request message in the de-spread wireless signal

The controller 316 may control the overall operation of the neighboring wireless device 120. When the probe request message is verified as a verification result of the probe request message verifying unit 314, the controller 316 may determine whether to respond to the probe request message.

When the controller 316 determines to respond to the probe request message, the controller 316 may control the probe request message generator 318 to generate a probe response message.

When the controller 316 determines to respond to the probe request message, the probe request message generator 318 may generate the probe response message according to control of the controller 316.

The spreader 320 may spread the generated probe response message using a predetermined spreading code.

The communication unit 310 may transmit the spread probe response message.

Hereinafter, a method of searching for a neighboring wireless device according to an embodiment of the present invention constructed as above will be described.

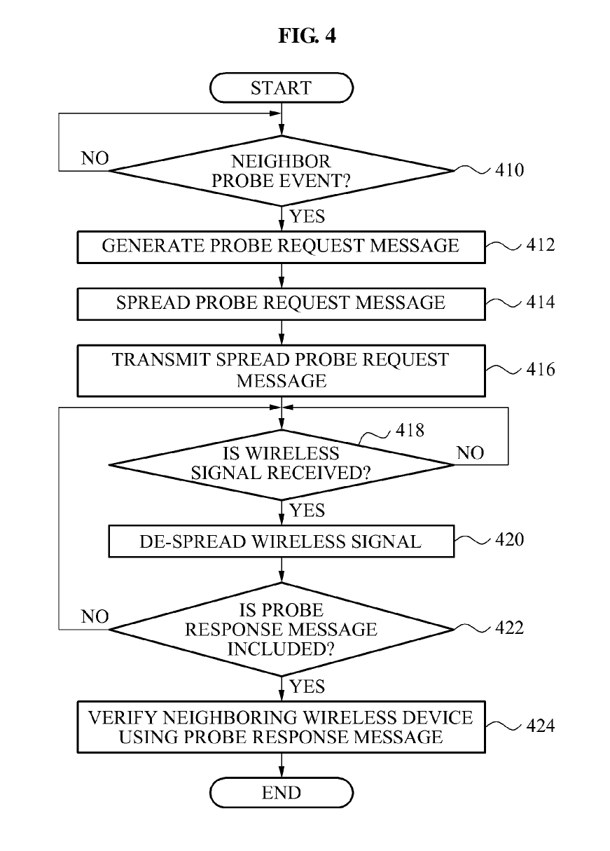

FIG. 4 is a flowchart illustrating a process in which the wireless device 110 searches for the neighboring wireless device 120 according to an embodiment of the present invention.

Referring to FIG. 4, in operation 410, the wireless device 410 may verify whether a neighbor probe event has occurred. When the neighbor probe event occurs, the wireless device 110 may generate a probe request message for searching for neighboring wireless devices in operation 412.

In operation 414, the wireless device 110 may spread the probe request message using a predetermined spreading code. When a plurality of channels is to be searched, the wireless device 110 may spread the probe request message for each channel using a spreading code that is predetermined for each channel.

In operation 416, the wireless device 110 may transmit the spread probe request message. Here, when a plurality of channels is to be searched, the wireless device 110 may transmit, using each corresponding channel, the probe request message that is spread for each channel.

In operation 418, the wireless device 110 may verify whether a wireless signal is received.

When the wireless signal is received, the wireless device 110 may de-spread the received wireless signal using a spreading code that is predetermined for de-spreading in operation 420.

In operation 422, the wireless device 110 may verify whether a probe response message is included in the de-spread wireless signal.

When the probe response message is not included in the de-spread wireless signal, the wireless device 110 may return to operation 418 and then performing the above process.

On the contrary, when the probe response message is included in the de-spread wireless signal, the wireless device 110 may verify the presence of the neighboring wireless device 120 using the probe response message.

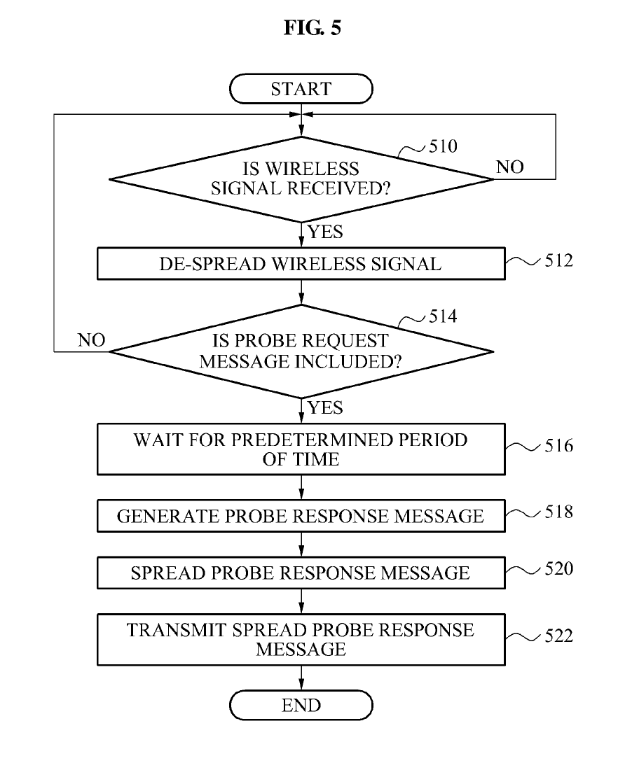

FIG. 5 is a flowchart illustrating a process in which the neighboring wireless device 120 responds to a probe request according to an embodiment of the present invention.

Referring to FIG. 5, when the neighboring wireless device 120 receives a wireless signal in operation 510, the neighboring wireless device 120 may de-spread the received wireless signal using a spreading code that is predetermined for de-spreading in operation 512.

In operation 514, the neighboring wireless device 120 may verify whether a probe request message is included in the de-spread wireless signal.

When the probe request message is not included in the de-spread wireless signal as the verification result in operation 514, the neighboring wireless device 120 may return to operation 510 and then perform the above process.

On the contrary, when the probe request message is included in the de-spread wireless signal as the verification result in operation 514, the neighboring wireless device 120 may wait for a predetermined period of time in operation 516.

In operation 518, the neighboring wireless device 120 may generate a probe response message.

In operation 520, the neighboring wireless device 120 may spread the probe response message using a spreading code that is predetermined for spreading.

In operation 522, the neighboring wireless device 120 may transmit the spread probe response message.

The above-described exemplary embodiments of the present invention may be recorded in computer-readable media including program instructions to implement various operations embodied by a computer. The media may also include, alone or in combination with the program instructions, data files, data structures, and the like. The program instructions stored in the media may be specially designed and configured for the present invention, or may be known to those skilled in the art and thereby be implemented.

According to embodiments of the present invention, there is provided a wireless device and method for searching for a neighboring wireless device by transmitting a spread probe request message and receiving a spread probe response message from the neighboring wireless device. Therefore, it is possible to significantly decrease an amount of time used by the wireless device to search for the neighboring wireless device, thereby significantly decreasing an amount of time used for connection.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A wireless device to search for a neighboring device, comprising:
a probe request message generator to generate a probe request message for searching for neighboring wireless devices;
a spreader to spread the probe request message using a spreading code that is predetermined for spreading; and
a communication unit to broadcast the spread probe request message.

2. The wireless device of claim 1, wherein:
to the spreader spreads the probe request message for each channel using a spreading code that is predetermined for each channel, and
the communication unit transmits the spread probe request message through each corresponding channel.

3. The wireless device of claim 1, wherein:
the communication unit receives a wireless signal, and the wireless device further comprises:
a de-spreader to de-spread the wireless signal using a spreading code that is predetermined for de-spreading;
a probe response message verifying unit to verify a probe response message in the de-spread wireless signal; and
a controller to verify whether a neighboring wireless device is present using the probe response message.

4. The wireless device of claim 3, wherein when the probe response message is received, the controller estimates a distance from the neighboring wireless device having transmitted the probe response message, based on a predetermined standby time and a propagation delay time occurring in transmitting the probe request message and receiving the probe response message.

5. The wireless device of claim 4, wherein the predetermined standby time corresponds to an amount of standby time used until the neighboring wireless device transmits the probe response message after receiving the probe request message.

6. A neighboring wireless device responding to a probe request, comprising:
to a communication unit to receive a wireless signal;
a de-spreader to de-spread the wireless signal using a spreading code that is predetermined for de-spreading;
a probe request message verifying unit to verify a probe request message in the de-spread wireless signal; and
a controller to determine whether to respond to the probe request message.

7. The neighboring wireless device of claim 6, further comprising:
a probe response message generator to generate a probe response message when the controller determines to respond to the probe request message; and
a spreader to spread the probe response message using a spreading code that is predetermined for spreading,
wherein the communication unit broadcasts the spread probe response message.

8. The neighboring wireless device of claim 7, wherein when the controller determines to respond to the probe request message, the controller controls the spread probe response message to be transmitted when a predetermined standby time is elapsed after receiving the probe request message.

9. A method of searching for a neighboring device, the method comprising:
generating a probe request message for searching for neighboring wireless devices;
spreading the probe request message using a spreading code that is predetermined for spreading; and
broadcasting the spread probe request message.

10. The method of claim 9, wherein:
the spreading comprises spreading the probe request message for each channel, using a spreading code that is predetermined for each channel, and
the broadcasting comprises transmitting the spread probe request message through each corresponding channel.

11. The method of claim 9, further comprising:
receiving a wireless signal;
de-spreading the wireless signal using a spreading code that is predetermined for de-spreading;
verifying a probe response message in the de-spread wireless signal; and
verifying whether a neighboring wireless device is present using the probe response message, when the probe response message is included in the wireless signal.

12. The method of claim 11, further comprising:
detecting the neighboring wireless device having transmitted the probe response message, based on a predetermined standby time and a propagation delay time occurring in transmitting the probe request message and receiving the probe response message, when the probe response message is received.

13. The method of claim 12, wherein the predetermined standby time corresponds to an amount of standby time used until the neighboring wireless device transmits the probe response message after receiving the probe request message.

14. A method of responding to a probe request, the method comprising:
receiving a wireless signal;
de-spreading the wireless signal using a spreading code that is predetermined for de-spreading;
verifying a probe request message in the de-spread wireless signal; and
determining whether to respond to the probe request message when the probe request message is included in the wireless signal.

15. The method of claim 14, further comprising:
generating a probe response message when it is determined to respond to the probe request message;
spreading the probe response message using a spreading code that is predetermined for spreading; and
transmitting the spread probe response message.

16. The method of claim 15, wherein the transmitting comprises transmitting the spread probe response message when a predetermined standby time is elapsed after receiving the probe request message.
